(19) United States
(12) Patent Application Publication
(10) Pub. No.: US 2026/0063461 A1
(43) Pub. Date: Mar. 5, 2026

(54) MEASURING INSTRUMENT AND MOUNTING METHOD THEREOF

(71) Applicant: Shikuan QI, Huludao (CN)

(72) Inventor: Shikuan QI, Huludao (CN)

(21) Appl. No.: 19/382,739

(22) Filed: Nov. 7, 2025

Related U.S. Application Data
(63) Continuation of application No. PCT/CN2024/091607, filed on May 8, 2024.

(30) Foreign Application Priority Data
May 8, 2023 (CN) 202310520151.9

(51) Int. Cl. G01F 23/00

(52) U.S. Cl. CPC G01F 23/00

(57) ABSTRACT

A measuring instrument, the shape of the measuring instrument being a curved shape which matches the shape of an external structure of a device, so that the curved measuring instrument is mounted against the outer surface of the measured device. The measuring instrument is made into a curved liquid level gauge, and the measuring instrument is closely mounted to the measured device. The problems of heat tracing and accurate measurement for the instrument is solved using the temperature of the measured device itself.

### CROSS-REFERENCES TO RELATED APPLICATIONS

This application claims priority to Chinese Patent Application No. 202310520151.9, filed with the China National Intellectual Property Administration (CNIPA) on May 8, 2023, and titled “MEASURING INSTRUMENT AND MOUNTING METHOD THEREOF”, the entire contents of which are hereby incorporated by reference into this application.

### TECHNICAL FIELD

The invention relates to the field of automation instruments, the curved liquid level instrument belongs to the field of measuring instrument technology, and close-contact mounting belongs to the field of instrument installation. Specifically, the invention relates to a measuring instrument and a mounting method thereof.

### BACKGROUND ART

Now, due to the rapid advancement of science and technology, there has been significant progress in instrument and automation technology, along with a wide variety of liquid level gauges that exhibit excellent performance. Liquid level gauges are often divided into local liquid level gauges and remote liquid level gauges. Local liquid level gauges include glass plate, quartz tube, magnetic flap, etc. Remote liquid level gauges include magnetic flap remote level gauge, differential pressure level gauge, displacer liquid level gauge, float liquid level gauge, radar level gauge, guided wave radar level gauge, magnetostrictive level gauge, servo level gauge, electrical contact level gauge, single-chamber balancing container, double-chamber balancing container, tuning fork float level switch, etc.

Different types of liquid level gauges have their own advantages and disadvantages, and their adaptable working conditions and installation methods are different. Except for a few liquid level gauges (such as servo level gauges, float level gauges, tuning fork float switches, etc.) that are sometimes directly installed inside the equipment and do not require heat tracing and insulation, the vast majority of liquid level gauges (such as glass plate level gauges, quartz tube level gauges, magnetic flap level gauges, displacer liquid level gauges, guided wave radar level gauges, etc.), if installed outside the equipment, need to be equipped with external heat tracing and insulation layer during the cold winter. Some instruments require cold insulation in summer. If the cold insulation is not installed properly, it will also cause abnormal instrument operation.

If the design of the instrument heating and insulation system is unreasonable, the installation does not meet requirements, or maintenance is lacking, it can lead to the failure of the heat tracing and insulation, preventing the instrument from reaching its operating conditions and causing it to fail to function properly. Using the example of steam tracing, the heat tracing system generally consists of a main inlet gas pipe, main return gas pipe, and various parallel heat tracing branches; if multiple instruments are connected in series on a heat tracing branch line, with many bending points and high positions, the resistance of this branch line increases, which will lead to a reduction in the flow rate of the heat tracing pipeline, a drop in temperature, and may even cause the heat tracing line to freeze and clog. Defects in heat tracing and insulation construction can result in incomplete installation of heating pipes for the instruments or measurement lines, and some local parts of the instrument measurement lines may not be adequately heated, leading to temperature drops or freezing, which can cause instrument failure. Blockages or leaks in the heat tracing pipes can also render the heat tracing and insulation system ineffective. Lack of instrument maintenance and management, such as inadequate inspection and maintenance, can cause small, localized instrument heat tracing and insulation issues to gradually evolve into larger, regional instrument heat tracing and insulation problems. This is especially critical for instruments measuring water-containing media. If freezing or blockage occurs, it could even result in the freezing or cracking of liquid level gauges or measurement lines, potentially causing leakage of flammable, explosive, toxic, or hazardous substances, leading to major fire or explosion accidents. This is not an exaggeration. Some even refer to freezing, blockage, or condensation of instrument or measurement lines as the “winter killer.” Therefore, managing this “winter killer” is crucial.

Generally, the heat tracing, heat preservation, and insulation of liquid level instruments only need to ensure that the measured medium in the instrument remains within a reasonable temperature range. However, some instruments require very precise compensation, such as the single-chamber and double-chamber balancing containers frequently used in boilers. Currently, these instruments still generate measurement errors and malfunctions that cannot be ignored due to structural limitations, improper installation and use, and changes in ambient temperature.

Heat tracing and insulation must ensure that the temperature of the instrument or instrument measurement pipeline is no lower than the temperature at which it can operate normally. The heat tracing temperature should not be too low, nor should it be too high. Still taking steam tracing as an example, for materials with a low boiling point in the instrument or measurement pipeline, the use of steam tracing is highly likely to cause the medium inside the instrument or instrument pipeline to boil, known as the “boiling over” phenomenon, which can lead to fluctuations or inaccuracies in liquid level measurement. Therefore, the temperature for heat tracing, heat preservation, and cold insulation must be neither too low nor too high, but should be within a reasonable range.

For certain high-viscosity or high-freezing-point media, a high temperature must be maintained inside the instrument or instrument pipeline. This requires good heat tracing and insulation, and the temperature of the instrument or instrument measurement pipeline must be maintained within a high and reasonable range; otherwise, the liquid level instrument cannot work properly.

Sometimes for certain media, the instrument may not be afraid of cold, but a rise in temperature can cause the instrument indication to fluctuate. For example, a magnetic flap level gauge on a liquefied gas storage tank, when not equipped with an insulation layer and subjected to scorching sunlight, may experience liquid level fluctuations due to the vaporization of the liquefied gas.

For a hot water tracing and insulation system, similar to the steam tracing system, it requires the installation of tracing pipelines throughout the unit, and may also require independent water supply systems such as hot water pumps and buffer tanks.

For an electric heat tracing system, in addition to considering the unit's power supply issues, its explosion-proof requirements must also be considered. In summary, whether it is steam tracing, hot water tracing, or electric tracing, it requires significant equipment investment, energy consumption, excellent heat tracing and insulation design, and meticulous maintenance after the plant starts operation.

Normal operation of the instrument is conditional. If phenomena such as freezing, condensation, crystallization, or precipitation of the material in the instrument or instrument measurement pipeline occur at ambient temperatures, steam tracing should be employed. However, the tracing temperature cannot be too high either, as excessive heat can easily raise the temperature of the instrument and the measured medium beyond the instrument's normal operating temperature, leading to instrument failure. This indicates that the temperature of instrument heat tracing and insulation cannot be high. Substandard installation and maintenance can lead to the freezing and condensation of the measured medium, which, at best, causes inaccurate measurement by the liquid level gauge and creates production problems, leading to unit fluctuations. For certain high-viscosity or high-freezing-point media, a high temperature must be maintained inside the instrument or instrument pipeline. This requires good heat tracing and insulation, and the temperature of the instrument or instrument measurement pipeline must be maintained within a high and reasonable range; otherwise, the liquid level instrument cannot work properly.

The single-chamber balancing container and double-chamber balancing container used for boiler liquid level measurement are mature and highly important liquid level instruments. Since most boilers operate at high temperatures and pressures, and the upper drum diameter is relatively small, water shortages and excessive water in the boiler drum are extremely dangerous. Therefore, accurate measurement and stable operation of the boiler liquid level remain of great significance. Due to structural and usage environment limitations, the single-chamber and double-chamber liquid level gauges still have areas that need improvement, such as further increasing accuracy and addressing heat tracing and insulation issues.

Common tracing methods use hot water, steam, or electricity. Hot water and steam tracing require a large amount of piping, valves, and insulation materials. Electric tracing requires a large number of heat tracing tapes, insulation materials, and related electrical components. If explosion-proof requirements exist, the cost will be even higher. In conclusion, whether it is hot water tracing, steam tracing, or electric tracing, they all require considerable installation costs, energy consumption costs, and maintenance costs, and the routine maintenance workload is relatively large.

### SUMMARY OF THE INVENTION

Therefore, the technical problem to be solved by the present application is to overcome the existing problems associated with heat tracing and insulation methods for instruments, namely: high material input cost, high installation cost, high thermal energy consumption, heavy daily maintenance workload, high failure rate, and the significant threat posed to safe production in winter. This is achieved by providing a measuring instrument and a mounting method thereof, so as to improve the measurement accuracy of the instrument, ensure that the instrument operates normally when the equipment operates normally, and guarantee the safe, stable, long-period, and high-accuracy operation of the instrument.

To achieve the above-mentioned objectives, the technical solution adopted in this application is as follows:
a measuring instrument, wherein the shape of the measuring instrument matches the shape of an external structure of a measured device, so that the measuring instrument is mounted against to an external surface of the measured device, ensuring that both the measuring instrument and the measured device are insulated together.

As an optional technical solution, the measuring instrument is configured to be curved, linear, or a combination of both curved and linear shapes;
the measuring instrument comprises a measuring cylinder, and the measuring instrument further comprises a transmitter assembly and/or a local display assembly.

As an optional technical solution, the measuring instrument is configured as a single-segment or multi-segment type.

As an optional technical solution, the measuring instrument comprises a curved measuring cylinder, the curved measuring cylinder is communicated with liquid phase of the measured device through a first tap pipe, and the curved measuring cylinder is communicated to gas phase of the measured device through a second tap pipe.

As an optional technical solution, both the first and second tap pipes are each provided with a tap valve.

As an optional technical solution, the curved measuring cylinder is connected to the measured device by a curved tap pipe, a straight-through tap valve, an angle valve, a short-sized tap valve, or without using a tap valve, with a downstream impulse line connected to the measured device, achieving a close-mounted installation.

As an optional technical solution, the transmitter assembly and/or the local display assembly are of a curved shape.

As an optional technical solution, the curved measuring cylinder is provided with one or more sensor interfaces and/or transmitter interfaces, the sensor interface is located at a top, bottom, or middle of the curved measuring cylinder, while the transmitter interface is located at an upper, lower, or middle part of the curved measuring cylinder, the transmitter assembly comprises a transmitter positioned at the transmitter interface and a transmitter probe rod that extends into an interior of the curved measuring cylinder, or a transmitter probe rod laid outside the curved measuring cylinder;

additionally, the curved measuring cylinder is provided with a filtration assembly and/or a plug.

As an optional technical solution, the first tap pipe and the second tap pipe are respectively connected to the curved measuring cylinder in a full-bore manner;
alternatively, the curved measuring cylinder may have one or several holes at connection sites of the tap pipes, an inner diameter of the holes is smaller than a diameter of the first and/or second tap pipe.

As an optional technical solution, the measuring instrument is a curved liquid level gauge, linear liquid level gauge, float liquid level gauge, dual-flange liquid level gauge, single-flange pressure transmitter, external liquid level switch, direct-mounted pressure transmitter, or pressure gauge;
the curved liquid level gauge comprises both a curved local liquid level gauge and a curved remote liquid level gauge;
the curved liquid level gauge is a curved glass liquid level gauge, a curved glass tube liquid level gauge, a curved magnetic flap liquid level gauge, a curved electrical contact liquid level gauge, a curved capacitance liquid level gauge, a curved external radio frequency admittance level gauge, a curved magnetostrictive level gauge, a curved reed-switch liquid level gauge, a curved boiler single-chamber water level gauge, a curved double-chamber balancing container, a curved external guided wave radar level gauge, a curved external radar level gauge, or a curved ultrasonic level gauge.

As an optional technical solution, when the curved boiler single-chamber water level gauge or the curved double-chamber balancing container measures the boiler liquid level, and under the condition that the measuring instrument is insulated along with the equipment, the temperature of the curved liquid level gauge is the same as the steam drum temperature, thereby ensuring that the specific weight of reference water column is constant at that temperature, and the impulse line is mounted in tight contact to eliminate errors caused by temperature differences in the impulse line.

As an optional technical solution, the measuring instrument undergoes linear compensation or no linear compensation during use.

As an optional technical solution, the measuring instrument is designed as a linear type that must meet one of the following conditions:
a connecting line between center points of the device's opening holes for the two tap valves of the measuring instrument is a straight line along a surface of the measured device;
a curvature of the measured device surface is small, and the distance of close-contact mounting meets operating temperature requirements of the liquid level measuring instrument.

A measuring instrument mounting method, wherein the measuring instrument is configured to have a shape adapted to that of the measured device, and the measuring instrument is installed in tight contact, at equal intervals, or at unequal intervals with an outer surface of the measured device, so that the measuring instrument and the measured device collectively provide thermal insulation.

As an optional technical solution, the close-contact mounting method of the measuring instrument includes one of the following methods:
A. the measuring instrument is in tight contact with the outer surface of the measured device;
B. the measuring instrument is parallel to the outer surface of the measured device with a gap;
C. the measuring instrument is not parallel to a curved surface of the measured device, and the distance is unequal.

As an optional technical solution, a implementation method of the close-contact mounting method of the measuring instrument includes one of the following methods:
a. arranging the tap pipe, the tap valve, and the downstream impulse line along the surface of the measured device, so that the measuring instrument is in close contact with the measured device or maintains a distance;
b. removing the tap valve, or shortening the length of the tap pipe, the tap valve, and the downstream impulse line, so that the measuring instrument and the surface of the measured device are in close contact or maintain a distance;
c. using the tap pipe, the angle valve, and the downstream impulse line to make the measuring instrument and the surface of the measured device in close contact) or maintain a distance.

As an optional technical solution, an insulation layer is laid between the measuring instrument and the measured device to satisfy the operating temperature conditions of the measuring instrument; or no insulation layer is laid between the measuring instrument and the measured device.

The technical solution of this application has the following advantages:
1. the measuring instrument provided by the present application is configured as a curved liquid level gauge. The measuring instrument is installed in close contact with the measured device, utilizing the measured device's inherent temperature to solve the problems of instrument heat tracing and precise compensation. This enables the liquid level instrument to achieve long-term stable operation without external heat tracing. The close contact mounting of the curved liquid level instrument and the adhered device will comprehensively improve the reliability, economical efficiency, and safety of instrument operation. In terms of cost, it significantly saves on expenses for heat tracing materials, insulation materials, installation, thermal energy, and daily maintenance;
2. the present application adopts a curved liquid level gauge and uses instruments with adherent installation, which eliminates unfavorable factors affecting instrument accuracy and improves the overall measurement accuracy of the instrument;
3. the measuring instrument provided by the present application is configured as a multi-segment type, which can solve problems related to manufacturing, transportation, and installation;
4. the measuring instrument provided by the present application features the first tap pipe, the second tap pipe, and the tap valve being installed in close contact with the outer surface of the measured device. The measuring instrument adhering to device and the device measuring the liquid level are collectively insulated to achieve the goals of heat tracing-free, precise measurement, and long-term stable operation;
5. the measuring instrument provided by the present application features a filter component and/or a plug arranged on the curved measuring cylinder to facilitate drainage and calibration. The specific position of the plug can be a top or bottom of the curved measuring cylinder;
6. the measuring instrument provided by the present application features the curved measurement barrel having one or several holes opened at the connection site of the tap pipe, and the inner diameter of the hole(s) is smaller than the diameter of the first tap pipe and/or the second tap pipe, which can reduce the measurement error of certain types of transmitters at the tap pipe opening;
7. the measuring instrument provided by the present application features the curved measuring cylinder configured as two parallel measurement pipes to meet the need for redundancy measurement;
8. the installation method for the measuring instrument provided by the present application involves making the measuring instrument into a curved shape to adapt to the shape of the measured device, providing the condition for the measuring instrument and the measured device to fit together tightly or maintain a small distance (equal or unequal spacing). The basic method is to route the tap pipe and the tap valve of the measuring instrument along the surface of the device, enabling the curved liquid level gauge and the traditional liquid level gauge to fit tightly with the device and be collectively insulated; this achieves the objectives of external heat tracing-free, precise measurement, long-term, safe, stable, and energy-efficient operation of the instrument;
9. the installation method for the measuring instrument provided by the present application features the curved liquid level gauge the liquid level gauge being installed in close contact, these two components are as an organic whole, being two aspects of a single solution; only when they are applied in mutual coordination can the curved liquid level instrument adhere to the device surface and be collectively insulated, utilizing the device body temperature to ensure that the instrument measuring cylinder is at the same temperature as the device or maintains the instrument within a suitable and ideal operating temperature range;
close-contact mounting is applicable not only to the curved liquid level gauge, but also to instruments suitable for adherent installation, such as double-flange, single-flange, direct-mount pressure transmitters, and pressure gauges;
10. the installation method for the measuring instrument provided by the present application, featuring the curved liquid level gauge and close-contact mounting, when used for boiler liquid level measurement with a single-chamber or double-chamber balancing container, ensures that, due to the use of the curved liquid level gauge and under insulated conditions, the temperature of the curved liquid level gauge is the same as that of the steam drum; this guarantees the constant specific gravity of the reference water column at that temperature; in addition, the close-contact mounting of the impulse lines eliminates errors caused by temperature differences in the impulse lines, further improving the accuracy of boiler liquid level measurement;
since the medium inside the steam drum is saturated steam, knowing its temperature or pressure allows one to determine the density of the steam phase and water phase in the upper steam drum at that time; furthermore, the steam drum pressure or temperature can be introduced into the differential pressure liquid level gauge or control system to achieve correction of the liquid level during variable operating conditions or the start-up process of the boiler, realizing accurate liquid level measurement during abnormal operating conditions or the boiler start-up process, and achieving dynamic correction of boiler liquid level measurement.

### BRIEF DESCRIPTION OF ACCOMPANYING DRAWINGS

To more clearly illustrate the technical solutions in the specific embodiments of this application or the prior art, the drawings used in the description of the specific embodiments or the prior art will be briefly introduced below. Obviously, the drawings described below are some embodiments of this application. For those skilled in the art, other drawings can be obtained from these drawings without much creative effort.

FIG. 1 is a schematic structural diagram of the curved measuring cylinder of the present application.

FIG. 2 is a schematic structural diagram of another perspective of the curved measuring cylinder of the present application.

FIG. 3 is a partially enlarged view of FIG. 2 of the present application.

FIG. 4 is a schematic structural diagram of the curved (polyline type) glass liquid level gauge of the present application.

FIG. 5 is a schematic structural diagram of the B-direction view of FIG. 4 of the present application.

FIG. 6 is a schematic structural diagram of the curved magnetic flap liquid level gauge of the present application.

FIG. 7 is a schematic structural diagram of the curved electrical contact liquid level gauge of the present application.

FIG. 8 is a schematic structural diagram of another perspective of the curved electrical contact liquid level gauge of the present application.

FIG. 9 is a schematic structural diagram of a first perspective of the curved boiler single-chamber water level gauge of the present application.

FIG. 10 is a schematic structural diagram of a second perspective of the curved boiler single-chamber water level gauge of the present application.

FIG. 11 is a schematic structural diagram of a third perspective of the curved boiler single-chamber water level gauge of the present application.

FIG. 12 is a schematic structural diagram of the intermediate-tap type double-chamber balancing container.

FIG. 13 is a schematic structural diagram of the standard type double-chamber balancing container.

FIG. 14 is a schematic structural diagram of the improved double-chamber balancing container.

FIG. 15 is a schematic structural diagram of the curved double-chamber balancing container of the present application.

FIG. 16 is a schematic structural diagram of a second perspective of the curved double-chamber balancing container of the present application.

FIG. 17 is a schematic structural diagram of a third perspective of the curved double-chamber balancing container of the present application.

FIG. 18 is a schematic structural diagram during the installation of the curved external guided wave radar level gauge of the present application.

FIG. 19 is a schematic structural diagram of the curved external guided wave radar level gauge of the present application.

FIG. 20 is a schematic structural diagram of the curved external radar level gauge of the present application.

FIG. 21 is a schematic structural diagram of the curved radio frequency admittance level gauge of the present application.

FIG. 22 is a schematic structural diagram of a curved capacitance level gauge (angle valve installation) of the present application.

FIG. 23 is a schematic structural diagram of a second perspective of a curved capacitance level gauge of the present application.

FIG. 24 is a schematic structural diagram of a third perspective of a curved capacitance level gauge of the present application.

FIG. 25 is a schematic structural diagram of a first perspective of the displacer level gauge in close-contact mounting of the present application.

FIG. 26 is a schematic structural diagram of the second perspective of the displacer level gauge (straight level gauge) in close-contact mounting of the present application.

FIG. 27 is a schematic structural diagram of a third perspective of the displacer level gauge in close-contact mounting of the present application.

FIG. 28 is a schematic structural diagram of a first perspective when the measuring instrument of the present application is a double-flange close-contact mounting structure.

FIG. 29 is a schematic structural diagram of a second perspective when the measuring instrument of the present application is a double-flange close-contact mounting structure.

FIG. 30 is a schematic structural diagram of a third perspective when the measuring instrument of the present application is a double-flange adherent installation structure.

FIG. 31 is a schematic structural diagram during the installation of a gas pipeline pressure gauge of the present application.

In the figures: 1 transmitter interface, 2 gas phase tap pipe, 3 flange, 4 curved measuring cylinder, 5 liquid phase tap pipe, 6 plug, 7 drain valve, 8 bolt, 9 magnetic float level gauge measuring cylinder, 10 nut, 11 magnetic indicator, 12 magnetic float, 13 electrode, 14 gas phase tap valve, 15 gas phase downstream impulse line, 16 balancing pot, 17 liquid phase tap valve, 18 liquid phase downstream impulse line, 19 reference water pipe, 20 instrument impulse line, 21 differential pressure transmitter, 22 five-way valve, 23 slag discharge valve, 25 curved guided wave radar antenna, 26 radar antenna centering plate, 27 radar level gauge, 29 capacitance curved measurement pipe, 30 capacitance probe, 31 capacitance transmitter, 32 container, 34 screw plug, 35 glass plate needle valve, 36 curved glass plate, 38 curved gland, 39 U-bolt, 40 double-flange transmitter, 41 pressure gauge, 42 displacer transmitter, 43 guided wave radar transmitter.

### SPECIFIC EMBODIMENT OF THE INVENTION

The technical schemes in the embodiments of the invention will be clearly and completely described in combination with the accompanying drawings in the embodiments of the invention. Obviously, the described embodiments are only some of the embodiments of the invention, but not all of the embodiments. Based on the embodiments in this invention, all other embodiments obtained by those of ordinary skill in the art without making creative efforts shall fall within the protection scope of this invention.

In the description of the invention, it should be understood that the orientation or positional relationship indicated by the terms “center”, “upper”, “lower”, “horizontal”, “inner”, “outer” and so on are based on the orientation or positional relationship shown in the accompanying drawings, only for the convenience of describing the invention and simplifying the description, rather than indicating or implying that the indicated device or element must have a specific orientation, as well as a specific orientation structure and operation; therefore, it should not be construed as a limitation of the invention. In addition, the terms “first” and “second” are only used for descriptive purposes, and should not be understood as indicating or implying relative importance.

In the description of the invention, it should also be noted that the terms of “install”, “link”, “connect”, etc., should be generally understood unless there are specific restrictions or stipulations, for example, the “connect” may refer to fixed connection, detachable connection or integral connection; the “connect” may also refer to mechanical connection or electrical connection; the means of “connect” may be directly connected or indirectly connected through an intermediate medium, and may be internal communication between the two elements. For those skilled in the art, the specific meaning of the above terms in the invention can be understood according to the specific situation.

In addition, the technical features involved in the different embodiments of the present application described below can be combined with each other as long as they do not conflict with each other.

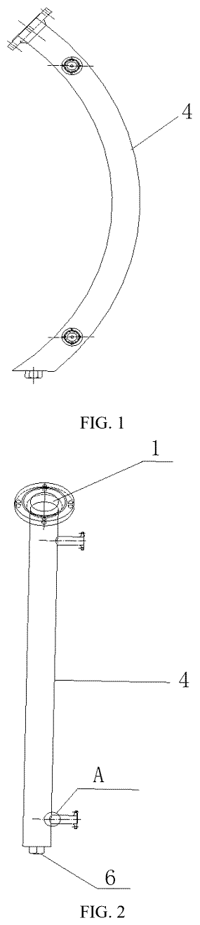

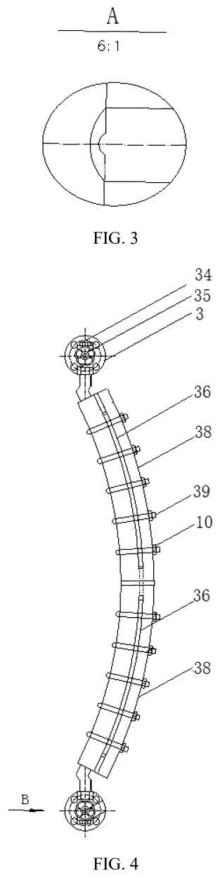

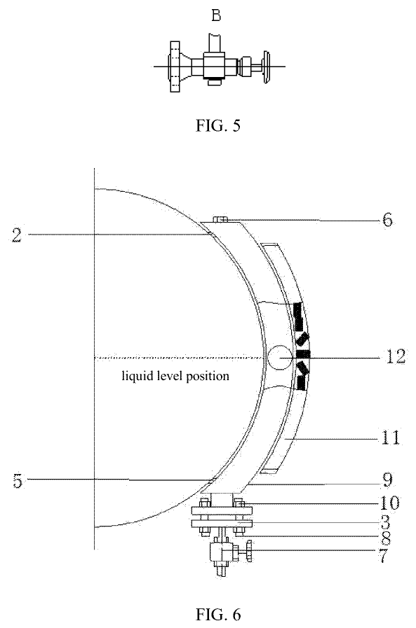

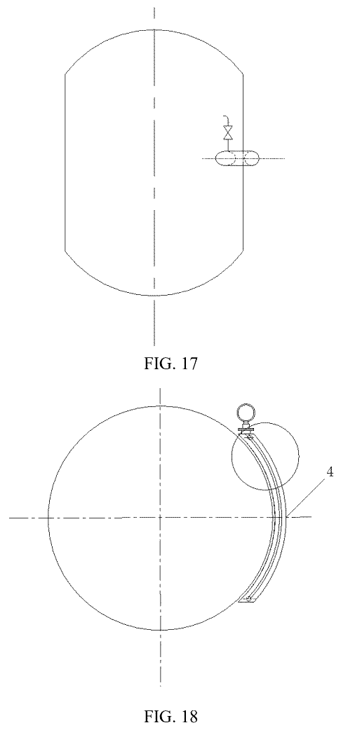

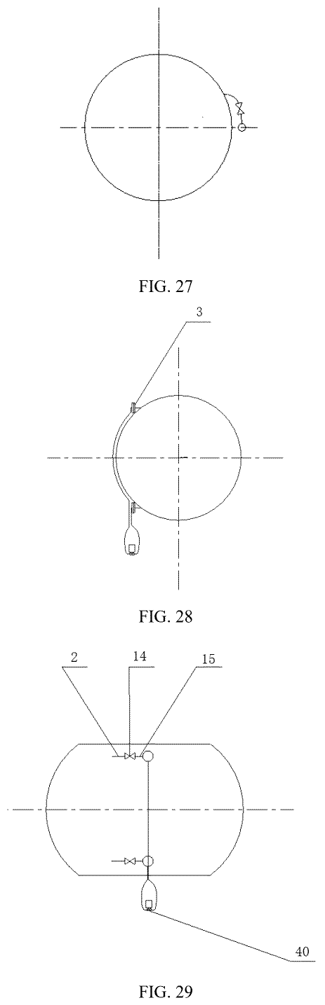

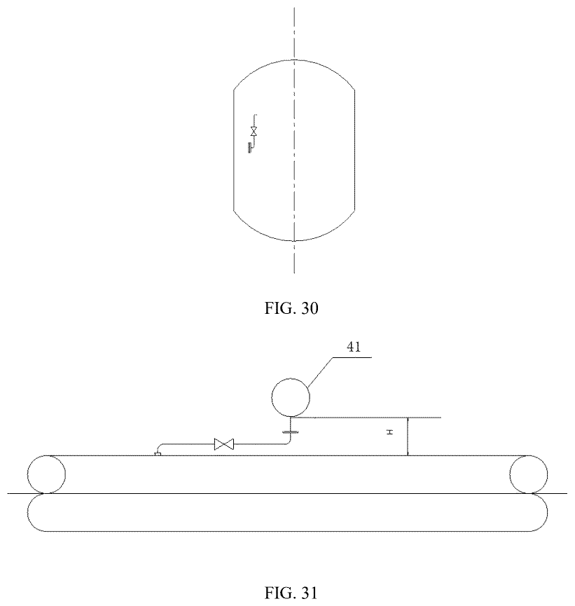

As shown in FIG. 1-FIG. 31, a measuring instrument, the shape of the measuring instrument matches the shape of an external structure of a measured device, so that the measuring instrument is mounted against to an external surface of the measured device. The present application achieves the installation of the curved liquid level gauge or straight liquid level gauge in close contact with the measured device, utilizing the measured device's inherent temperature to solve the problems of instrument heat tracing and precise measurement. This enables the measuring instrument to achieve the goals of long-term, safe, precise, stable operation, and maintenance-free status without the need for external heat tracing, while simultaneously saving substantial costs associated with heat tracing and insulation materials, installation fees, heat tracing energy consumption, and maintenance.

Close-contact mounting is a method where the instrument suitable for this type of installation is affixed to the surface of the measured device through various means, allowing them to be collectively insulated. Relying on the equipment's own heat or cold, and without the need for external heat tracing, the instrument can be maintained within the ideal operating temperature range, thus achieving the goals of higher accuracy, long-period, stable, and safe operation.

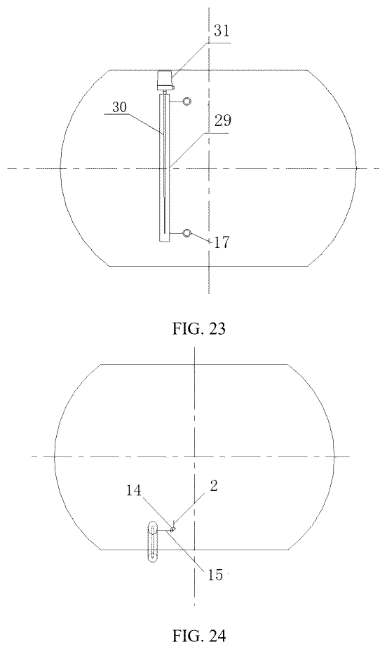

The present application includes two aspects: first, the curved (including polyline) liquid level gauge; current liquid level gauges are all manufactured in a straight configuration, which we refer to as a straight liquid level gauge to distinguish it from the curved type; the key point of the present application is that the liquid level gauge is manufactured in a curved shape, which is its most significant characteristic; this shape adapts to the surface configuration of the measured device and provides the condition for the liquid level gauge and the measured device to fit together tightly or maintain a small distance (equal or unequal spacing). Second, close-contact mounting of the instrument; the close-contact mounting is not only applicable to the curved liquid level gauge, but also to the straight liquid level gauge and level switch; one method for close-contact mounting is to arrange the tap pipe, tap valve, and downstream impulse line of the liquid level instrument along the surface of the device, enabling the curved or straight liquid level gauge to fit tightly to the device; the other method for close-contact mounting is that the angle valve can also be used to achieve close-contact mounting, as shown in FIGS. 23 and 24; a short-size valve can also be used, or even no tap valve can be used under conditions permitted by the process, to achieve close-contact mounting. The choice of the close-contact method-whether it is tight contact, small-distance contact, or unequal-distance contact, it is determined specifically by the type of instrument, the type of the device, and the process conditions.

The present application incorporates two technical innovations: the curved liquid level gauge and the close-contact mounting of the liquid level gauge. The two form an organic whole, being two aspects of a single solution. Only when they are applied in coordination can the curved liquid level instrument fit tightly to the surface of the device, be collectively insulated, and utilize the device body temperature to ensure that the curved measuring cylinder is at the same temperature as the device or maintains the instrument within a suitable and ideal operating temperature range.

The liquid level gauge close contacting the device and the device measuring the liquid level are collectively insulated to achieve the goals of heat tracing-free, precise measurement, and long-term stable operation.

The measuring instrument is configured as a curved type, a straight type, or a combination of curved and straight shapes, with adaptive adjustments made according to the shape of the measured device. There are many types of curved liquid level gauges, but their working principles are consistent with the corresponding traditional straight liquid level gauges.

The liquid level gauge is manufactured in a curved shape to adapt to the device surface shape, thereby achieving the close-contact mounting of the liquid level instrument on the device. Both the measuring cylinder of the curved liquid level gauge and its internal or external transmitter components are curved.

The measuring instrument can be configured as a single-segment type or a multi-segment type. Configuring the measuring instrument as a multi-segment type can solve problems related to manufacturing, transportation, and installation. The diameter and material of the measuring instrument vary depending on the transmitter and the operating conditions. The measuring instrument may sometimes require one curved segment or multiple curved segments, or even a combination of curved and straight segments, due to different device types or combinations of devices.

The measuring instrument comprises a curved measuring cylinder 4, the curved measuring cylinder 4 is communicated with the measured device through a first tap pipe and a second tap pipe, the curved measuring cylinder 4 is communicated with liquid phase of the measured device through the first tap pipe, and the curved measuring cylinder 4 is communicated to gas phase of the measured device through the second tap pipe, both the first and second tap pipes are each provided with a tap valve. The first tap pipe, the second tap pipe and the tap valves are respectively installed in close contact with the outer surface of the measured device. This allows them to fit tightly with the device. The measuring instrument adhered to the device and the device measuring the liquid level are collectively insulated, thereby achieving the objectives of heat tracing-free, precise measurement, and long-term stable operation.

The exit position of the first tap pipe and the second tap pipe is not limited to the area around upper and lower pipe sections of the curved measuring cylinder (i.e., the curved measuring cylinder), but can also be drawn out from its upper portion or lower portion. Their shape can be a straight segment, a curved segment, or a combination of the two.

The curved measuring cylinder 4 is an important component of a curved instrument. When combined with different types of curved transmitter assemblies, it forms different types of curved instruments.

The curved measuring cylinder 4 is provided with one or more sensor interfaces and/or transmitter interfaces, the sensor interface is located at a top, bottom, or middle of the curved measuring cylinder, while the transmitter interface 1 is located at an upper, lower, or middle part of the curved measuring cylinder 4, the transmitter assembly comprises a transmitter positioned at the transmitter interface, the quantity and position of the transmitter interfaces should be determined based on the type and number of transmitters. For example, one transmitter interface is generally sufficient for a guided wave radar, radar, capacitance transmitter, or radio frequency admittance transmitter. A double-chamber balancing container requires two sensor interfaces, and an electrical contact level gauge may require multiple sensor interfaces. A local magnetic flap level gauge does not require a transmitter interface. The sensor component (transmitter+sensor) can be installed on the upper part, lower part, inside, or outside of the measuring pipe, depending on the specific instrument type and usage conditions.

The transmitter interface can be made into different forms; flange and threaded interfaces are commonly used, and corresponding interfaces can also be configured according to the transmitter's connection type.

The curved measuring cylinder 4 is provided with a filtration assembly and/or a plug 6. The plug 6 can also be configured as a valve to facilitate drainage and calibration. The specific position of the plug 6 can be the top or bottom of the measuring cylinder 4, and its exact position is not limited thereto.

The connection port between the tap pipe and the curved measuring cylinder 4 can be of two types: first, the tap pipes are connected to the curved measuring cylinder 4 in a full-bore manner; second, the curved measuring cylinder 4 has one or several holes at connection sites of the tap pipes, an inner diameter of the holes is smaller than a diameter of the tap pipe, the advantage of is that it can reduce measurement errors for certain types of transmitters at the tap pipe opening holes. The curved measuring cylinder 4 can be configured as two parallel measurement pipes to meet the need for redundancy measurement.

The curved liquid level gauge comprises both a curved local liquid level gauge and a curved remote liquid level gauge. The measuring instruments include the curved (polyline type) glass plate liquid level gauge, curved glass tube (quartz, etc.) liquid level gauge, curved magnetic flap liquid level gauge, curved electrical contact level gauge, curved reed-switch liquid level gauge, curved magnetostrictive level gauge, curved external capacitance level gauge, curved external radio frequency admittance level gauge, curved boiler single/double chamber level gauge, curved external guided wave radar level gauge, curved external radar level gauge, curved ultrasonic level gauge, etc.

Linear compensation issues for curved remote level instruments: \textcircled{1} curved single/double chamber balancing containers, and close-contact installed double-flange/differential pressure liquid level gauges do not require linear compensation; \textcircled{2} the distribution of the electrical contacts in the electrical contact level gauge should be linear with respect to the liquid level; \textcircled{3} the curved capacitance liquid level gauge, curved reed-switch liquid level gauge, curved radio frequency admittance level gauge, curved magnetostrictive level gauge, curved guided wave radar level gauge, curved radar level gauge, and curved magnetic flap liquid level gauge with remote transmission can be used with or without linear compensation.

A characteristic of the liquid level gauge of the present application is that the measuring cylinder fits tightly with the measured device or maintains an appropriate distance from the measured device. The purpose is to utilize the device's temperature, and through appropriate insulation (without the need for heat tracing), ensure that the liquid level instrument remains within a suitable temperature range during operation. This guarantees that the instrument can operate stably for a long period, even for high-freezing-point media and water-containing media during the coldest winter.

To ensure the tight fit of the measuring cylinder to the measured device or to maintain a small distance, the measuring cylinder can be manufactured in a curved type, a polyline type, or a straight type. Furthermore, the installation method of the primary valve is changed from the usual perpendicular installation on the device to an installation parallel to the device. Angle valves, specially made short valves, or even no tap valve in special circumstances, can also be used.

The fundamental characteristic of the liquid level gauge in this application is that the liquid level gauge is adapted to the shape of the on-site device. The liquid level gauge fits tightly to the device measuring the liquid level or maintains an appropriate distance, and achieves precise measurement or keeps the liquid level gauge working within a suitable temperature range through insulation.

### Close-contact Mounting of Measuring Instrument

The present application also provides a measuring instrument mounting method, namely close-contact mounting. Not only is the curved liquid level gauge suitable for it, but the straight liquid level gauge or other instruments can also apply the close-contact mounting method under certain conditions. The linear type measuring instrument must meet one of the following conditions: 1. a connecting line between center points of the device's opening holes for the two tap valves of the measuring instrument is a straight line along a surface of the measured device; 2. a curvature of the measured device surface is small, and the distance of close-contact mounting meets operating temperature requirements of the liquid level measuring instrument.

For a curved equipment where the straight liquid level gauge is not suitable for close-contact mounting-that is, when the line connecting the center points of the two tap opening holes for the liquid level gauge on the device surface is a curve and the surface curvature is large-a curved liquid level gauge may be used. Through close-contact mounting, this achieves precise liquid level measurement without the need for an external heat tracing line. The present application involves configuring the liquid level measuring instrument to have a shape adapted to the shape of the measured device, and installing the liquid level measuring instrument in tight contact, at equal intervals, or at unequal intervals with the outer surface of the measured device.

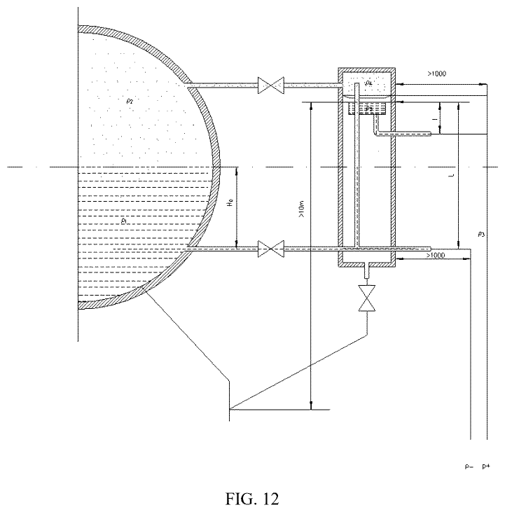

The basic characteristic of the standard installation of traditional liquid level gauges is that the tap pipe is not curved and is in a straight line with the tap valve, and the liquid level gauge is at a significant distance from the measured device (refer to FIGS. 12, 13, and 14). In order to prevent freezing and clogging in the instrument during cold seasons or with high-freezing-point media and to ensure normal operation, heat tracing and insulation are required for the instrument. For the tap valve and piping methods of liquid level gauges (such as straight liquid level gauges, double-flange, and other instruments suitable for close-contact mounting like single-flange, differential pressure level, and external level switches), the basic principle of the present application is to ensure that the instrument achieves tight contcat to the measured device or maintains a small distance (equal or unequal spacing). By insulating the instrument and the device together, the goal of heat tracing-free and precise measurement is achieved.

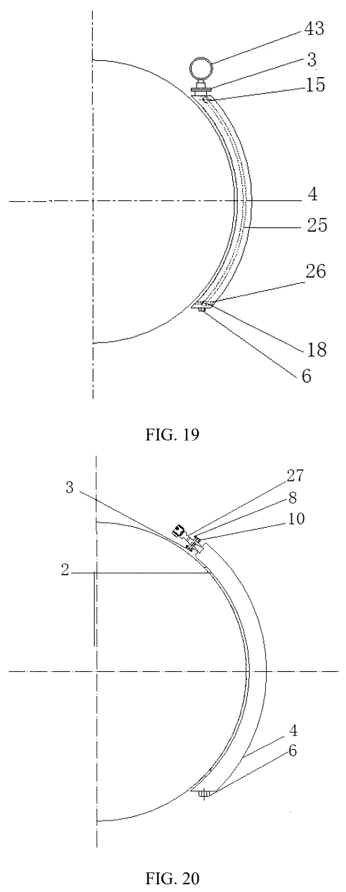

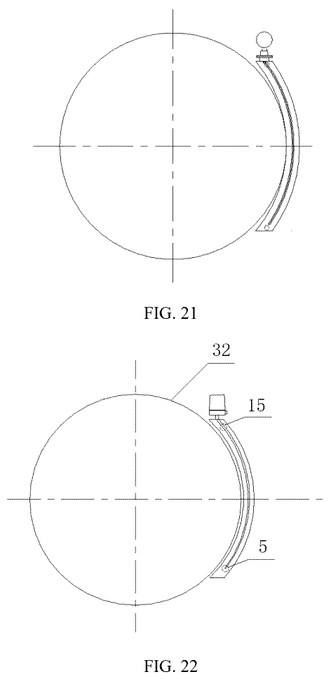

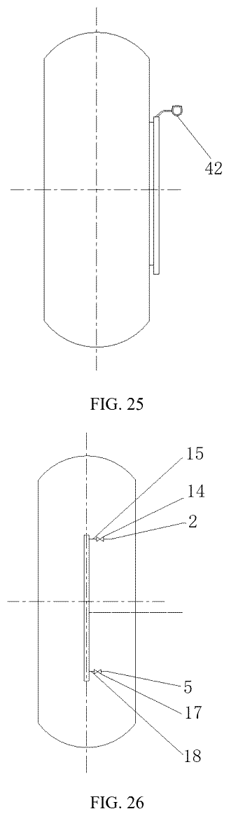

The close-contact mounting method of the measuring instrument includes one of the following ways: A. the measuring instrument is in tight contact with the outer surface of the measured device, as shown in FIG. 25 (Displacer type); B. the measuring instrument is parallel to the outer surface of the measured device with a gap, as shown in FIG. 19; C. the measuring instrument is not parallel to a curved surface of the measured device, and the distance is unequal, as shown in FIG. 21.

A implementation method of the close-contact mounting method of the measuring instrument includes one of the following methods:
a. arranging the tap pipe, the tap valve, and the downstream impulse line along the surface of the measured device, so that the measuring instrument is in close contact with the measured device or maintains a distance (equal or unequal spacing), referring to FIGS. 20 and 21;
b. removing the tap valve, so that the curved measuring cylinder and the adherently mountable instrument fit tightly with the device surface or maintain a small distance (equal or unequal spacing);
c. using the angle valve (for radio frequency admittance close contact) to make the measuring instrument and the surface of the measured device in close contact or maintain a distance (equal or unequal spacing), as shown in FIG. 24;
d. shortening the length of the tap pipe, the tap valve, and the downstream impulse line, installing the measuring instrument onto the surface of the measured device, so that the measuring instrument and the surface of the measured device are in close contact or maintain a distance (equal or unequal spacing); an insulation layer is laid between the measuring instrument and the the measured device together, satisfying the operating temperature conditions of the measuring instrument.

The curved liquid level gauges suitable for close-contact mounting include curved (polyline type) glass plate liquid level gauge, curved glass tube (quartz, etc.) liquid level gauge, curved magnetic flap liquid level gauge, curved electrical contact level gauge, curved reed-switch liquid level gauge, curved magnetostrictive level gauge, curved external capacitance level gauge, curved external radio frequency admittance level gauge, curved boiler single-chamber level gauge, curved boiler double-chamber level gauge, curved external guided wave radar level gauge, curved external radar level gauge, and curved ultrasonic level gauge.

The straight liquid level gauges suitable for close-contact mounting include straight glass plate liquid level gauge, straight glass tube (quartz, etc.) liquid level gauge, straight magnetic flap liquid level gauge, straight electrical contact level gauge, straight reed-switch liquid level gauge, straight magnetostrictive level gauge, straight external capacitance level gauge, straight external radio frequency admittance level gauge, straight boiler single-chamber level gauge, straight boiler double-chamber level gauge, straight external guided wave radar level gauge, straight external radar level gauge, straight float liquid level gauge, straight ultrasonic level gauge, straight displacer liquid level gauge, and straight external servo level gauge.

External level switches such as float and tuning fork can also apply the close-contact mounting method to achieve heat tracing-free mounting. The mounting method for the double-flange is also to route the impulse line, the tap valve, and the downstream impulse line along the curved (or flat) surface of the device, contacting closely to the device or maintaining a small distance. This mounting method can ensure that the two double-flanges have a consistent temperature, thereby achieving precise measurement. General liquid level instruments (straight liquid level gauges) and level communication devices can also use the close-contact mounting method to achieve heat tracing-free mounting.

The curved or straight liquid level gauge, through the method of tight adherence, fits closely with the device measuring the liquid level, enabling the temperature of the medium in the liquid level gauge to be the same as the medium in the device to achieve precise measurement. When the curved liquid level gauge, straight liquid level gauge, and level switch adhere closely to the measured device and are collectively insulated, the medium within the liquid level gauge and the medium within the measured device are in completely identical physical states. Characteristic parameters such as the medium's temperature, density, and dielectric constant are consistent. The liquid level and interface within the measuring cylinder are also the same as those in the measured device, which provides the most fundamental condition for precise liquid level measurement. For glass plate, quartz tube, electrical contact, double-chamber balancing container, capacitance, radio frequency admittance, local remote magnetic flap, magnetostrictive, guided wave radar, and radar level gauges, this makes precise measurement achievable.

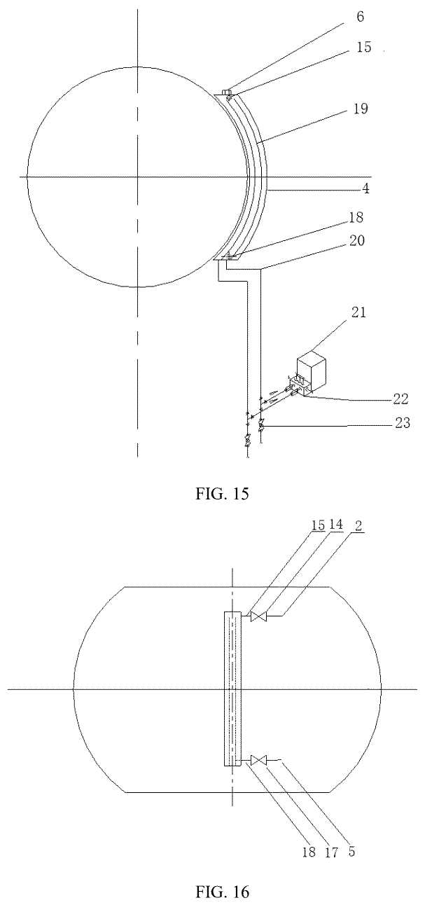

For example, when the double-chamber balancing container widely used in boilers is manufactured as a curved liquid level gauge and installed in tight contact with the upper steam drum, the water-steam temperature of the double-chamber balancing container becomes the same as the steam temperature of the upper drum. The static pressure of its reference water column then corresponds to its temperature (or pressure). If the boiler steam drum pressure or temperature is stable, the static pressure of the reference water column is constant, thus ensuring precise liquid level measurement. FIG. 15 shows a schematic diagram of the installation of a curved double-chamber balancing container.

For single/double chamber boiler curved liquid level gauge measurement, since the medium inside the steam drum is saturated steam, knowing its temperature or pressure allows one to determine the density of the steam phase and water phase in the upper steam drum at that time. Furthermore, the steam drum pressure or temperature can be introduced into a differential pressure liquid level gauge or control system to achieve correction of the liquid level in the steam drum under varying operating conditions or during the startup process. This enables accurate liquid level measurement during abnormal operating conditions or the boiler start-up process, achieving dynamic correction of boiler liquid level measurement.

By maintaining a small distance (equal or unequal spacing) between the curved and adherently installable instrument and the device, and by enclosing both the liquid level gauge and the measured device together with an insulation layer, the liquid level instrument is maintained within the most suitable and safest temperature range, achieving the objective of external heat tracing-free. Refer to FIG. 21, which is a schematic diagram of the unequal-distance close-contact mounting of a curved liquid level gauge.

### Embodiment 1

The measuring instrument provided in this embodiment is a curved (polyline type) glass plate liquid level gauge, as shown in FIGS. 4 to 6.

The purpose of manufacturing the glass plate and glass tube liquid level gauge in a curved shape is twofold: first, to solve the problem of freezing condensation and ice clogging for this type of liquid level gauge in low-temperature environments; and second, to enable a more accurate indication by the glass plate.

The curved liquid level gauge is applicable to transparent glass level gauges, reflex glass level gauges, sight-glass plate level gauges, and various forms of glass plate level gauges derived from the above three forms, and naturally also includes blind-zone-free glass plate level gauges.

Taking the reflex glass plate liquid level gauge as an example, its shape and composition are illustrated below. Visible components in FIG. 4 comprise a screw plug 34, a glass plate needle valve 35, a flange 3, a curved body, a curved glass plate 36, a curved gland 38, a curved gasket, U-bolts 39, and nuts 10. Both the curved body and the curved glass plate 36 are configured to be curved. The curved glass plate 36 is configured in the shape of a curved segment and is positioned onto the curved body by a number of fixing components. The connection components are the nuts 10 and the U-bolts 39, or other locating forms may be employed.

The structural components of this reflex glass plate liquid level gauge are similar to those of a straight glass plate liquid level gauge. Similarly, the curved glass plate liquid level gauge also includes a steel ball anti-leakage device for glass plate breakage, the only difference lying in its curved shape.

The curved glass plate liquid level gauge can also take another form: the polyline type glass plate liquid level gauge. The overall shape of this type of glass plate level gauge is formed by combining a series of straight segments to create the overall polyline type glass liquid plate level gauge.

### Embodiment 2

The measuring instrument provided in this embodiment is a curved magnetic flap liquid level gauge, as shown in FIG. 6. The magnetic flap liquid level gauge is in communication with the measured device, and the liquid level between the measured device and the measurement pipe is balanced. When the float in the measurement pipe changes with the liquid level, the magnetism in the float interacts with the magnetic display strips or the remote transmission components, causing them to flip and change color for local indication. The remote signal is introduced into the control system to realize remote monitoring of the liquid level. The curved magnetic flap liquid level gauge comprises a drain valve 7, bolts 8, flanges 3, nuts 10, a magnetic float level gauge measuring cylinder 9, a magnetic indicator 11, a magnetic float 12, a plug 6, and a remote transmission component.

The measuring cylinder is curved and adapted to the shape of the device surface.

The magnetic flap liquid level gauge is curved and should adapt to the shape of the device surface. If the device has multiple curved segments, the corresponding magnetic float level gauge should also have multiple curved segments.

The shape of the magnetic float should ensure smooth movement inside the curved measuring cylinder to accurately measure the liquid level. Its shape and geometric dimensions are designed accordingly based on the measuring cylinder's diameter and curvature.

A remote transmitter can be externally added, and its shape should be consistent with the curved curvature of the measuring cylinder.

The remote curved magnetic float can perform correction on the measured value, and the basis for correction is the shape of the curve.

The curved magnetic flap liquid level gauge can be equipped with filtering and anti-clogging facilities. The function of the filtering and anti-clogging facilities is to prevent impurities inside the measurement pipe from causing blockage and affecting the float.

### Embodiment 3

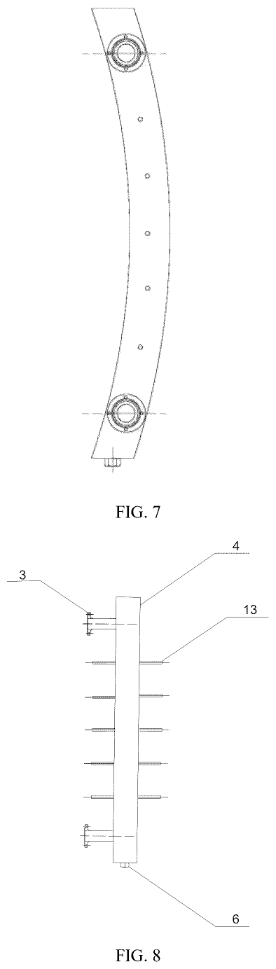

The measuring instrument provided in this embodiment is a curved electrical contact liquid level gauge, as shown in FIGS. 7 and 8. The difference between the curved electrical contact liquid level gauge and the straight electrical contact liquid level gauge lies in the fact that the measuring cylinder is changed from a straight shape to a curved shape. The advantage of this is that it solves the problem of heat tracing and insulation for the externally installed electrical contact liquid level gauge, and achieves higher measurement accuracy.

The curved electrical contact liquid level gauge and the straight electrical contact liquid level gauge have the same measurement principle, and its principle will not be elaborated upon here.

The composition of a general curved electrical contact liquid level gauge is described below. The curved electrical contact liquid level gauge comprises a curved measuring cylinder 4, a gas phase tap pipe 2, flanges 3, electrodes 13, a liquid phase tap pipe 5, and a plug 6. Multiple electrodes 13 are provided and are arranged at intervals on a surface of the curved measuring cylinder 4. An arrangement with linearized correction is preferred. The plug 6 is disposed at a bottom of the curved measuring cylinder 4. A flange 3 is respectively disposed on the gas phase tap pipe 2 and the liquid phase tap pipe 5.

### Embodiment 4

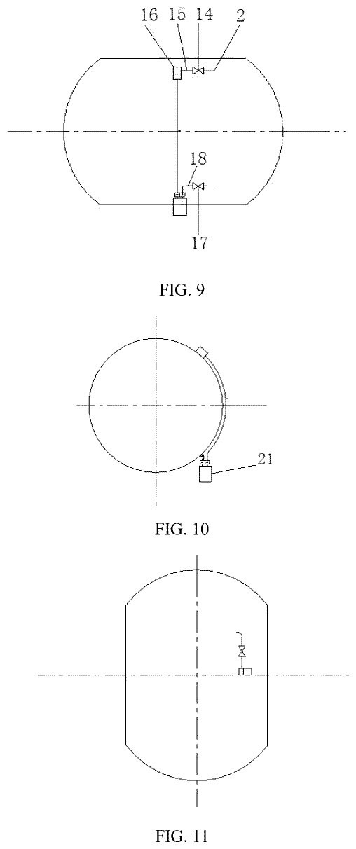

The measuring instrument provided in this embodiment is a curved boiler single-chamber water level gauge (i.e., a curved single-chamber balancing container), as shown in FIGS. 9 to 11.

The curved single-chamber balancing container comprises a gas phase tap pipe 2, a gas phase tap valve 14, a gas phase downstream impulse line 15, a balancing pot 16, a liquid phase tap pipe 5, a liquid phase tap valve 17, a positive pressure impulse line, a negative pressure impulse line, and a differential pressure transmitter 21.

The gas phase tap pipe, liquid phase tap pipe, and positive and negative pressure impulse lines in this embodiment are all curved pipe segments to adapt to the shape of the boiler's side wall and to adhere better to the boiler's side wall.

FIG. 9 is a schematic diagram of the single-chamber adherent installation. Its installation features include the following points:
1. the gas phase tap pipe, the gas phase tap valve, the gas phase downstream impulse line, the balancing pot, the liquid phase tap pipe, the liquid phase tap valve, the liquid phase downstream impulse line, a segment of the positive pressure impulse line, and a segment of the negative pressure impulse line are all contacting closely to the boiler drum;
2. the valves, pipes, and balancing pot installed in a close-contact manner are insulated along with the equipment;
3. the differential pressure transmitter is disposed near the steam drum and utilizes the heat conducted by the impulse lines to maintain it under normal working conditions.

The close-contact mounting of the tap pipes, impulse lines, and balancing pot in this embodiment ensures that their operating temperature is consistent with the steam drum, thereby achieving precise measurement.

### Embodiment 5

Boiler liquid level measurement is the most critical requirement for precise measurement. The steam drum water level is an essential parameter for safe boiler operation. A high water level or sharp fluctuation can affect the efficiency of steam-water separation, increasing steam wetness, leading to a decrease in steam quality; this easily causes scaling in the superheater and the flow passages of the turbine, potentially leading to superheater tube ruptures and a decrease in unit thermal efficiency. When the water level is high to a certain extent, the steam will carry water, which may lead to destructive accidents. An excessively low water level will cause air entrainment in the downcomers, affecting the boiler water circulation conditions, and in severe cases, can lead to extensive damage to the water walls, potentially resulting in major safety accidents.

The double-chamber balancing container is one of the most common and better-performing instrument devices for measuring the steam drum liquid level. The significance of inventing the curved double-chamber balancing container will be demonstrated below through the analysis and comparison of different structural forms of the double-chamber balancing container.

The double-chamber balancing container can be divided into the standard type, the intermediate-tap type, and the improved double-chamber balancing container. Structurally, the intermediate-tap type comprises a condensing chamber, a datum ring, an overflow chamber, a communicator, and a downcomer. The steam-side connecting tube introduces saturated steam into the double-chamber balancing container and releases the latent heat of vaporization, condensing into saturated water, which is led into the datum cup by a guide plate. The datum cup transmits the pressure generated by the condensate water to a positive pressure side of the measuring instrument—the differential pressure transmitter through the pressure guide tube. After the datum cup is filled with condensate water, the excess overflows into the overflow chamber, maintaining a constant liquid level height of the condensate water in the datum cup, as shown in FIG. 12.

The excess condensate water in the overflow chamber is introduced into the boiler downcomer through a guide tube. To ensure a certain differential pressure between the overflow tube and the downcomer, the height difference between the downcomer's opening height and the datum cup's height is generally greater than 10 meters. Simultaneously, the heat released by the condensation of saturated steam inside the container heats the balancing container, causing the balancing container's temperature to approach the temperature inside the steam drum. A [symbol] shaped connector on the negative pressure side has a horizontal part connected to the steam drum at one end and to the negative pressure side of the transmitter at the other end. The differential pressure transmitter determines the steam drum water level by measuring the pressure difference between the positive and negative pressure sides. The liquid level and temperature inside a vertical tube of the [symbol] shaped connector are the same as the boiler liquid level.

For the intermediate-tap type double-chamber balancing container, referring to FIG. 12, under normal operation of the downcomer, τ₁=τ₃, τ₂=τ₄. The formula for calculating the differential pressure is as follows:

$$Δ P = {P}_{+} - {P}_{-} = [ \text{?} {ρ}^{3} + ( L - \text{?} ) {ρ}^{4} ] g - [ ( L - {H}_{0} ) {ρ}^{4} + {H}_{0} {ρ}^{3} ] g \qquad ( 1 )$$

$$Δ P = {P}_{+} - {P}_{-} = [ \text{?} {ρ}^{1} + ( L - \text{?} ) {ρ}^{2} ] g - [ ( L - {H}_{0} ) {ρ}^{2} + {H}_{0} {ρ}^{1} ] g \qquad ( 2 )$$

$$\text{?} \text{indicates text missing or illegible when filed}$$

Wherein ΔP₋ is output differential pressure of the double-chamber balancing container, P₊ is output pressure of the positive pressure side of the balancing container, P is output pressure of the negative pressure side of the balancing container, τ¹ is density of saturated water, τ² is density of saturated steam, τ³ is density of water inside the [symbol] shaped connector of the double-chamber balancing container, τ⁴ is density of steam inside the double-chamber balancing container, l is a vertical height between the datum cup opening and the centerline of the horizontal pipe of the L-shaped pressure guide tube, L is a vertical height between the datum cup opening and the centerline of the horizontal pipe of the communicator, and g is acceleration of gravity.

Referring to FIG. 12 and analyzing its advantages and disadvantages, in the differential pressure calculation formula, L, l, and g are constants. It is the downcomer that provides the circulation of saturated steam condensate for the balancing container, essentially ensuring that the temperature inside the balancing container is the same as the temperature in the steam drum. Therefore, under normal operating conditions, τ¹ and τ² are also constants. This is the significant advantage of the double-chamber balancing container. However, τ³ is the density of water at ambient temperature, making it a variable, and thus it introduces errors into the measurement.

The disadvantages of the double-chamber balancing container can be summarized as follows: 1. although the downcomer provides the circulation of saturated steam condensate for the balancing container, essentially guaranteeing that the temperature inside the balancing container is the same as the temperature in the steam drum; the impulse lines on the steam side and water side of the double-chamber balancing container are located in the surrounding environment of the boiler, the temperature is thus a variable, and the static pressure of the reference water column will change accordingly, leading to errors in liquid level measurement; if the balancing container's impulse lines require insulation in winter, the influence on the temperature of the impulse lines cannot be ignored. 2. If the downcomer is clogged or obstructed, it will increase the circulating resistance of the condensate. In severe cases, if the condensate cannot circulate, the temperature inside the balancing container and the density of the reference water column inside the instrument's impulse lines will severely deviate from normal operating conditions, making the instrument unable to operate normally. Furthermore, fluctuations in boiler load can cause fluctuations in the downcomer's drawing force, which in turn affects pressure fluctuations inside the balancing container, leading to fluctuations in the indication of the differential pressure level transmitter. 3. The influence of heat tracing and insulation on the double-chamber balancing container: whether or not to apply heat tracing and insulation to the double-chamber balancing container, and how to carry it out if needed, is a controversial topic. The basic principle of the present application is that it should be determined on a case-by-case basis and cannot be generalized. The key focus here is that if heat tracing and insulation are applied, an excessively high temperature in the impulse lines will severely deviate from the design conditions of the double-chamber balancing container, leading to serious instrument errors. 4. When the downcomer circulation is poor or the environment where the double-chamber balancing container is located has a very low temperature, and also due to its own high temperature and large amount of radiated heat to the outside, the temperature of the double-chamber balancing container may be lower than the temperature inside the steam drum. This causes the density of the water in the reference water column to increase, resulting in instrument errors.

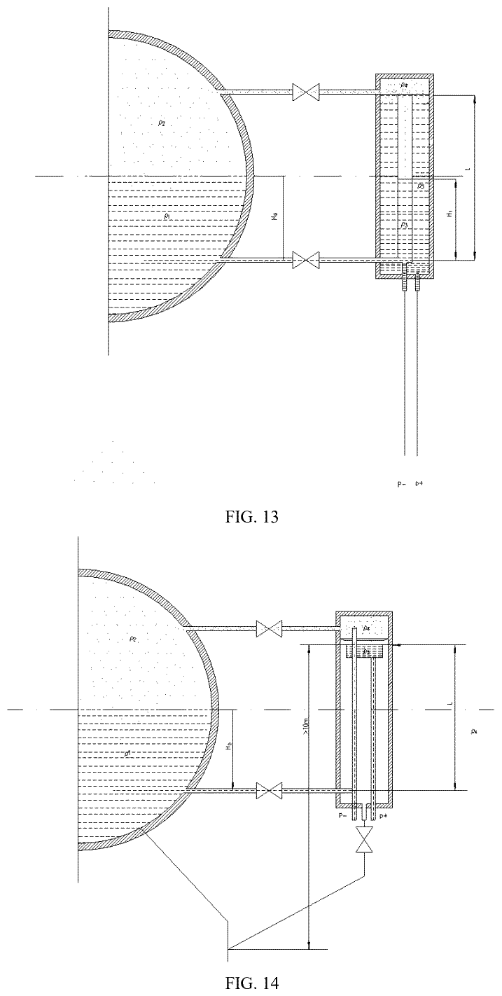

Referring to FIG. 13 for the standard type double-chamber balancing container, its differential pressure calculation is as follows:

$$Δ P = {P}_{+} - {P}_{-} = [ {H}_{1} {ρ}_{3} + ( L - {H}_{1} ) {ρ}_{4} ] g - L {ρ}_{3} g \qquad ( 3 )$$

$$Since {H}_{0} {ρ}_{1} g = {H}_{1} {p}_{3} g + ( L - {H}_{1} ) {ρ}_{4} g$$

$${H}_{1} = \frac{{H}_{0} {ρ}_{1} - L {ρ}_{4}}{{ρ}_{3} - {ρ}_{4}} \qquad ( 4 )$$

$$After sorting ,$$

$$Δ = {P}_{+} - {P}_{-} = \frac{{H}_{0} {ρ}_{1} - L {ρ}_{4}}{{ρ}_{3} - {ρ}_{4}} {ρ}_{3} g + L {ρ}_{4} g - \frac{{H}_{0} {ρ}_{1} - L {ρ}_{4}}{{ρ}_{3} - {ρ}_{4}} {ρ}_{4} g - L {ρ}_{4} g \qquad ( 5 )$$

Wherein ΔP₋ is output differential pressure of the double-chamber balancing container, P₊ is output pressure of the positive pressure side of the balancing container, P₋ is output pressure of the negative pressure side of the balancing container, τ¹ is density of saturated water, τ² is density of saturated steam, τ³ is density of gas phase of the standard double-chamber balancing container, τ⁴ is density of steam inside the standard double-chamber balancing container, H₀ is steam drum saturated water level, H₁ is water level in the communicating tube of the double-chamber balancing container, and g is acceleration of gravity.

Compared with the intermediate-tap type double-chamber balancing container, the standard double-chamber balancing container has the advantage that it has no downcomer, has a simpler structure, and avoids problems such as poor circulation, clogging that might be caused by the downcomer, and pressure fluctuations in the double-chamber balancing container due to changes in boiler load will not occur. However, its disadvantage is that because it has no thermal circulation loop, the temperature of the double-chamber balancing container gradually decreases from top to bottom. As can be seen from the differential pressure calculation formula (4), τ₃ and τ₄ will change with the operating conditions, ambient temperature changes, and the heat tracing and insulation status. When the actual operating conditions and ambient temperature deviate from the design conditions, a density difference will arise between τ₃ and τ₂, between τ₄ and τ₂. The magnitude of this difference depends on the degree of deviation of the operating conditions and ambient temperature from the design. The differential pressure ΔP received by the liquid level differential pressure transmitter will thus deviate from the correct value, causing an instrument measurement error.

For the improved double-chamber balancing container, refer to FIG. 14. Under normal operation of the downcomer, τ₁=τ₃, τ₂=τ₄. The differential pressure calculation formula is as follows:

$$Δ P = {P}_{+} - {P}_{-} = L {ρ}_{3} g - [ ( L - {H}_{0} ) {ρ}_{4} + {H}_{0} {ρ}_{3} ] g \qquad ( 6 )$$

$$Δ P = {P}_{+} - {P}_{-} = L {ρ}_{1} g - [ ( L - {H}_{0} ) {ρ}_{2} + {H}_{0} {ρ}_{1} ] g \qquad ( 7 )$$

Wherein ΔP is output differential pressure of the double-chamber balancing container, P₊ is output pressure of the positive pressure side of the balancing container, P₋ is output pressure of the negative pressure side of the balancing container, τ₁ is density of saturated water, τ₂ is density of saturated steam inside the steam drum, τ₃ is density of water inside the [symbol] shaped connector of the double-chamber balancing container, τ₄ is density of steam inside the double-chamber balancing container, H₀ is steam drum saturated water level, L is a vertical height between the datum cup opening and the centerline of the horizontal pipe of the communicator, and g is acceleration of gravity.

The improved design retains most of the advantages of the intermediate-tap type double-chamber balancing container. L is an inherent dimension of the double-chamber balancing container. H₀ is a liquid level variable, only one parameter, τ₁, is a sole potential variable, and it is stable under normal operating conditions. As can be seen from the AP calculation formula, this type of double-chamber balancing container can measure the boiler liquid level with relatively high accuracy, overcoming the drawback of the reference water column density being affected by the environment. However, there is still a long tail problem: the inherent disadvantage of the downcomer still exists, the structure is relatively complex, and if the downcomer circulation is poor, it will severely affect the accuracy of liquid level measurement; additionally, changes in boiler load will cause pressure fluctuations inside the double-chamber balancing container, leading to liquid level fluctuation.

In order to solve the aforementioned technical problems, the curved double-chamber balancing container of the present application comprises a gas phase tap pipe 2, a gas phase tap valve 14, a gas phase downstream impulse line 15; a liquid phase tap pipe 5, a liquid phase tap valve 17, a liquid phase downstream impulse line 18; a plug 6; a reference water pipe 19; a curved measuring cylinder 4; an instrument impulse line 20; a differential pressure transmitter 21; a five-way valve 22; and a slag discharge valve 23. Boiler steam is connected to a gas phase side of the boiler through the gas phase tap pipe 2, the gas phase tap valve 14, and the gas phase downstream impulse line 15. The gas phase tap valve 14 is arranged between the gas phase tap pipe 2 and the gas phase downstream impulse line 15. Boiler water is connected to a liquid phase side of the boiler through the liquid phase tap pipe 5, the liquid phase tap valve 17, and the liquid phase downstream impulse line 18. The liquid phase tap valve 17 is arranged between the liquid phase tap pipe 5 and the liquid phase downstream impulse line 18.

The tap pipe and the downstream impulse line are curved pipe segments and are connected in series with the tap valve. They are installed in tight contact along the device surface and are insulated along with the steam drum. The reference water pipe 19 and the curved measuring cylinder 4 are adapted to the steam drum surface and have the same curvature.

FIGS. 15 to 17 show schematic diagrams of a curved double-chamber balancing container according to the present application. The difference between the curved double-chamber balancing container and the straight double-chamber balancing container is that the measuring cylinder and its internal components of the straight double-chamber balancing container are made into a curved shape to become the curved double-chamber balancing container. The double-chamber balancing container has many different structural forms, all of which are derived from the basic form. The curved double-chamber balancing container is applicable to all forms of double-chamber balancing containers.

The curved double-chamber balancing container and its close-contact mounting solve the problem of inconsistency between the temperature inside the straight double-chamber balancing container and the temperature inside the steam drum. This temperature difference can affect the measurement error of the double-chamber balancing container, where a larger temperature difference leads to a larger measurement error. Installing and insulating the two impulse lines in tight adherence simultaneously solves the problem of deviation in the differential pressure liquid level instrument caused by changes in ambient temperature of the instrument impulse lines, resulting in more precise measurement. At the same time, it eliminates the need for external heat tracing of the measuring cylinder.

The downstream impulse line of the liquid phase tap valve can be connected to an outside of the reference water pipe or to an inside of the reference water pipe.

Referring to FIG. 15 for the curved double-chamber balancing container, under normal operating conditions, τ₁=τ₃, τ₂=τ₄. The differential pressure calculation formula is as follows:

$$Δ P = {P}_{+} - {P}_{-} = L {ρ}_{3} g - [ ( L - {H}_{0} ) {ρ}_{4} + {H}_{0} {ρ}_{3} ] g \qquad ( 6 )$$

$$Δ P = {P}_{+} - {P}_{-} = L {ρ}_{1} g - [ ( L - {H}_{0} ) {ρ}_{2} + {H}_{0} {ρ}_{1} ] g \qquad ( 7 )$$

Wherein ΔP is output differential pressure of the double-chamber balancing container, P₊ is output pressure of the positive pressure side of the balancing container, P₋ is output pressure of the negative pressure side of the balancing container, τ₁ is density of saturated water, τ₂ is density of saturated steam inside the steam drum, τ₃ is density of water inside the [symbol] shaped connector of the double-chamber balancing container, τ₄ is density of steam inside the double-chamber balancing container, H₀ is steam drum saturated water level, L is a vertical height between the datum cup opening and the centerline of the horizontal pipe of the communicator, and g is acceleration of gravity.

As can be seen from the differential pressure calculation formulas (6) and (7), the calculation formula for the curved double-chamber balancing container is the same as that of the improved double-chamber balancing container. The structural difference is the absence of a downcomer, and consequently, the instrument operational problems caused by the downcomer also disappear. Additionally, the straight double-chamber balancing container is made into a curved shape, which allows it to adhere tightly to the steam drum and be insulated along with it. This ensures that the temperature inside the double-chamber balancing container is consistent with the temperature inside the steam drum, thus achieving precise measurement.

The curved double-chamber balancing container of this embodiment can guarantee its temperature consistency with the steam drum simply by relying on its structural characteristics. It does not need to rely on the circulation of water and steam in the downcomer to maintain its internal temperature to be the same as the steam drum. By eliminating the downcomer of the intermediate-tap double-chamber balancing container and implementing the close-contact mounting of the pressure-sensing pipes, errors caused by changes in ambient temperature and insulation factors are eliminated. Furthermore, with the addition of temperature or pressure compensation, the curved double-chamber balancing container is thus simpler in structure and higher in accuracy, while also reducing liquid level instrument operational failures caused by water plugging and physical blockage in the downcomer.

### Embodiment 6

The measuring instrument provided in this embodiment is a curved external guided wave radar level gauge, as shown in FIGS. 18 and 19.

The curved external guided wave radar level gauge comprises a guided wave radar transmitter 43, a flange 3, a gas phase tap pipe 2, a curved measuring cylinder 4, a curved guided wave radar antenna 25, a radar antenna centering plate 26, a liquid phase tap pipe 5, a plug 6, and so on.

The curved external guided wave radar level gauge is composed of a curved guided wave radar and a curved measuring cylinder. The curved radar level gauge is suitable for rod antennas (single-rod and double-rod), coaxial antennas, and cable antennas. The process interface is suitable for flange, threaded, and other non-standard interfaces.

The curved rod antenna is fixed using a centering plate or centering ring. The number of centering rings can be one or more, and the position is determined based on the form and length of the antenna, ensuring that the radar level gauge antenna is on the centerline of the measurement pipe and in a stable and tensioned state. Generally, the fewer centering plates and centering rings, the better.

The degree of curvature and shape of the measurement pipe and the curved guided wave radar antenna are determined by the curved surface of the device on which it is installed, and there may be one curve, two curves, or even more.

The plug can also be modified into a drain valve to facilitate drainage and calibration.

### Embodiment 7

The measuring instrument provided in this embodiment is a curved external radar level gauge, as shown in FIG. 20.

The radar level gauge and the curved measurement pipe constitute the curved radar level gauge. Its advantage lies in solving the problem of heat tracing and insulation for externally mounted radar level gauges, increasing measurement precision, lowering installation precision requirements, and making the maintenance and calibration of the level gauge more convenient.

The main installation methods for radar level gauges are flange type and threaded type. The main forms of radar antennas are rod type, horn type, parabolic type, and planar antenna. The installation method for the curved radar level gauge is suitable for all types of radar level gauge installation methods and antenna forms.

Taking the horn-type radar level gauge as an example, its composition is described as follows: radar level gauge 27, bolt 8, nut 10, curved measuring cylinder 4, plug 6, flange 3, gasket, and tap pipe.

### Embodiment 8

The measuring instrument provided in this embodiment is a curved radio frequency admittance level gauge. FIG. 21 is a schematic diagram of the close-contact mounting of the curved radio frequency admittance level gauge. In addition to possessing all the characteristics of a curved instrument, it has one further characteristic: the measurement pipe and the device have inconsistent curvature, and the degree of adherence varies at different points. This is an example of unequal-distance adherence within the close-contact mounting method. However, the measurement pipe can be insulated together with the device, ensuring that the measurement pipe remains within a suitable working environment.

### Embodiment 9

The liquid level measuring instrument provided in this embodiment is a curved capacitance level gauge, as shown in FIGS. 22 to 24. The composition of the curved capacitance instrument system: a gas phase tap pipe 2, a gas phase tap valve 14, a gas phase downstream impulse line 15; a liquid phase tap pipe 5, a liquid phase tap valve 17, a liquid phase downstream impulse line 18, a capacitance curved measurement pipe 29, a capacitance probe 30, a capacitance transmitter 31, and a container 32.

The curved capacitance level gauge is composed of a curved capacitance probe, a capacitance transmitter, and a curved measurement pipe. The process interface is suitable for flange, threaded, and other non-standard interfaces.

The tap valve of the curved capacitance level gauge adopts an angle valve for installation. The gas phase and liquid phase tap pipes should be as short as possible to facilitate close-contact mounting. The downstream impulse line is a curved pipe segment, and the angle valve serves the function of changing the direction of the tap pipe and shortening the length of the valve section of the impulse line.

The degree of curvature and shape of the measurement pipe and the curved capacitance probe are determined by the curved surface of the device on which it is installed. It may be a single curve, two curves, or several curves, or a combination of curved and straight segments.

The rod probe is fixed using a centering plate or centering ring. The number of centering rings can be one or more, and the position is determined based on the strength and length of the rod probe, ensuring that the capacitance probe is on a centerline of the measurement pipe and in a stable and tensioned state.

The plug within the system can also be modified into a drain valve.

### Embodiment 10

The measuring instrument provided in this embodiment is a displacer-type measuring instrument installed by close-contact mounting, as shown in FIGS. 25 to 27. The measuring instrument in this embodiment comprises a gas phase tap pipe 2, a gas phase tap valve 14, a gas phase downstream impulse line 15, a liquid phase tap pipe 5, a liquid phase tap valve 17, a liquid phase downstream impulse line 18, and a displacer transmitter 42.

FIG. 25 is a schematic diagram of the displacer close-contact mounting, which is also one example of the close-contact mounting of a straight instrument. The tap pipes are curved pipe segments. The routing characteristic is to adhere to the device surface or maintain a small distance (to facilitate insulation along with the device). The valve connection methods are threaded, flanged, or welded. The downstream impulse lines are curved pipe segments. The routing characteristic is to adhere to the device surface or maintain a small distance (to facilitate insulation along with the device).

This embodiment can be configured as top-side, bottom-side, or top-bottom close-contact mounting methods. The installation method of the measuring instrument is not limited here.

The displacer level gauge is a straight liquid level gauge. Close-contact mounting of a straight liquid level gauge needs to satisfy one of the following two conditions: \textcircled{1} the line connecting the two tap valves of the liquid level gauge along the device surface is straight; \textcircled{2} the surface curvature of the device is small and the adherence distance can meet the operating temperature requirements of the instrument. This example satisfies the first condition.

### Embodiment 11

The liquid level measuring instrument provided in this embodiment is a double-flange close-contact mounting structure, comprising a gas phase tap pipe 2, a gas phase tap valve 14, a gas phase downstream impulse line 15, a flange 3, a double-flange transmitter 40, a liquid phase tap pipe, a liquid phase tap valve, and a liquid phase downstream impulse line, as shown in FIGS. 28 to 30.

The tap pipes are curved pipe segments. The routing characteristic is to adhere to the device surface or maintain a small distance (to facilitate insulation along with the device).

The connection method of the gas phase tap valve 14 is threaded connection, flanged connection, or welding.

The downstream impulse lines are curved pipe segments. The routing characteristic is to adhere to the device surface or maintain a small distance (to facilitate insulation along with the device).

The angle between a tangent plane at a intersection point of the interface flange's centerline and the device, and the interface flange plane can be different. Capillary tubes of the double-flange can be laid within the insulation layer of the device in cold regions to ensure they are maintained at a suitable ambient temperature.

### Embodiment 12

The liquid level measuring instrument provided in this embodiment is a gas pipeline pressure gauge, comprising: a branch pipe seat, a tap pipe, a tap valve, an impulse line, a pressure gauge 41, a pressure gauge connector, and a pressure gauge gasket, as shown in FIG. 31.

The branch pipe seat is a compensation-type pipe fitting for pressure gauge connection. The tap pipe is a pipe segment that may include a curved section, connected to the branch pipe seat at one end and connected to the tap valve at the other end. Both ends of the tap pipe are connected to the branch pipe seat and the tap valve, respectively. The tap valve is a device used to open or close the extraction of media such as steam, water, or oil from process equipment or pipelines; the tap valve type, material, connection method, and parameters should comply with instrument installation specifications; double valves or a double valve set may be required to meet high-pressure needs. The impulse line is a pipe segment located after the tap valve and before the pressure gauge, which may include a curved section; one end is connected to the tap valve, and the other end can be connected directly to the pressure gauge connector, or to a T-fitting, a pressure gauge siphon, a two-way valve, a drain valve, an isolation pot, etc., to suit different operating conditions; the pressure gauge connector is welded to the impulse pipe at one end and connected to the pressure gauge at the other end; the pressure gauge is an instrument used to indicate pressure and send high pressure alarm and low pressure alarm signals.

The tap position of the pressure gauge should be determined according to pressure tapping standards. FIG. 31 is an installation diagram for a gas pipeline pressure gauge, with the tap position located at an upper part of the pipeline.

The characteristic of the close contact mounting of the pressure gauge is that the tap pipe and the impulse pipe are curved pipe segments, and the pipe fittings and valves of the pressure gauge pressure-sensing system route along the surface of the pipeline. They can adhere closely to the process pipeline or maintain a small distance. To ensure the tap pipe maintains a suitable temperature, an insulation layer can be laid around the process pipeline and the pipe fittings/valves. The insulation layer is laid within the dashed line area after the pressure gauge installation is completed.

The H value is selected such that the pressure gauge can be ensured to operate within its normal operating temperature range, assuming a standard insulation layer thickness.

It is evident that the embodiments described above are merely examples provided for the sake of clarity and are not intended to limit the implementation. For those of ordinary skill in the art, other variations or modifications in different forms can be made based on the preceding description. It is neither necessary nor possible to exhaustively list all implementation methods here. The obvious variations or modifications derived therefrom still fall within the protection scope of the present application.

1. A measuring instrument, wherein the shape of the measuring instrument matches the shape of an external structure of a measured device, so that the measuring instrument is mounted against to an external surface of the measured device, ensuring that both the measuring instrument and the measured device are insulated together.

2. The measuring instrument of claim 1, wherein the measuring instrument is configured to be curved, linear, or a combination of both curved and linear shapes;
the measuring instrument comprises a measuring cylinder, and the measuring instrument further comprises a transmitter assembly and/or a local display assembly.

3. The measuring instrument of claim 2, wherein the measuring instrument is configured as a single-segment or multi-segment type.

4. The measuring instrument of claim 3, wherein the measuring instrument comprises a curved measuring cylinder, the curved measuring cylinder is communicated with liquid phase of the measured device through a first tap pipe, and the curved measuring cylinder is communicated to gas phase of the measured device through a second tap pipe.

5. The measuring instrument of claim 4, wherein both the first and second tap pipes are each provided with a tap valve.

6. The measuring instrument of claim 5, wherein the curved measuring cylinder is connected to the measured device by a curved tap pipe, a straight-through tap valve, an angle valve, a short-sized tap valve, or without using a tap valve, with a downstream impulse line connected to the measured device, achieving a close-mounted installation.

7. The measuring instrument of claim 4, wherein the transmitter assembly and/or the local display assembly are of a curved shape.

8. The measuring instrument of claim 7, wherein the curved measuring cylinder is provided with one or more sensor interfaces and/or transmitter interfaces, the sensor interface is located at a top, bottom, or middle of the curved measuring cylinder, while the transmitter interface is located at an upper, lower, or middle part of the curved measuring cylinder, the transmitter assembly comprises a transmitter positioned at the transmitter interface and a transmitter probe rod that extends into an interior of the curved measuring cylinder, or a transmitter probe rod laid outside the curved measuring cylinder;
additionally, the curved measuring cylinder is provided with a filtration assembly and/or a plug.

9. The measuring instrument of claim 4, wherein the first tap pipe and the second tap pipe are respectively connected to the curved measuring cylinder in a full-bore manner;
alternatively, the curved measuring cylinder may have one or several holes at connection sites of the tap pipes, an inner diameter of the holes is smaller than a diameter of the first and/or second tap pipe.

10. The measuring instrument of claim 4, wherein the measuring instrument is a curved liquid level gauge, linear liquid level gauge, float liquid level gauge, dual-flange liquid level gauge, single-flange pressure transmitter, external liquid level switch, direct-mounted pressure transmitter, or pressure gauge;
the curved liquid level gauge comprises both a curved local liquid level gauge and a curved remote liquid level gauge;
the curved liquid level gauge is a curved glass liquid level gauge, a curved glass tube liquid level gauge, a curved magnetic flap liquid level gauge, a curved electrical contact liquid level gauge, a curved capacitance liquid level gauge, a curved external radio frequency admittance level gauge, a curved magnetostrictive level gauge, a curved reed-switch liquid level gauge, a curved boiler single-chamber water level gauge, a curved double-chamber balancing container, a curved external guided wave radar level gauge, a curved external radar level gauge, or a curved ultrasonic level gauge.

11. The measuring instrument of claim 10, wherein when the curved boiler single-chamber water level gauge or the curved double-chamber balancing container measures the boiler liquid level, and under the condition that the measuring instrument is insulated along with the equipment, the temperature of the curved liquid level gauge is the same as the steam drum temperature, thereby ensuring that the specific weight of reference water column is constant at that temperature, and the impulse line is mounted in tight contact to eliminate errors caused by temperature differences in the impulse line.

12. The measuring instrument of claim 10, wherein the measuring instrument undergoes linear compensation or no linear compensation during use.

13. The measuring instrument of claim 2, wherein the measuring instrument is designed as a linear type that must meet one of the following conditions:
a connecting line between center points of the device's opening holes for the two tap valves of the measuring instrument is a straight line along a surface of the measured device;
a curvature of the measured device surface is small, and the distance of close-contact mounting meets operating temperature requirements of the liquid level measuring instrument.

14. A measuring instrument mounting method, wherein the measuring instrument is configured to have a shape adapted to that of the measured device, and the measuring instrument is installed in tight contact, at equal intervals, or at unequal intervals with an outer surface of the measured device, so that the measuring instrument and the measured device collectively provide thermal insulation.

15. The measuring instrument mounting method of claim 14, wherein the close-contact mounting method of the measuring instrument includes one of the following methods:
A. the measuring instrument is in tight contact with the outer surface of the measured device;
B. the measuring instrument is parallel to the outer surface of the measured device with a gap;
C. the measuring instrument is not parallel to a curved surface of the measured device, and the distance is unequal.

16. The measuring instrument mounting method of claim 15, wherein a implementation method of the close-contact mounting method of the measuring instrument includes one of the following methods:
a. arranging the tap pipe, the tap valve, and the downstream impulse line along the surface of the measured device, so that the measuring instrument is in close contact with the measured device or maintains a distance;
b. removing the tap valve, or shortening the length of the tap pipe, the tap valve, and the downstream impulse line, so that the measuring instrument and the surface of the measured device are in close contact or maintain a distance;
c. using the tap pipe, the angle valve, and the downstream impulse line to make the measuring instrument and the surface of the measured device in close contact) or maintain a distance.

17. The measuring instrument mounting method of claim 16, wherein an insulation layer is laid between the measuring instrument and the measured device to satisfy the operating temperature conditions of the measuring instrument; or no insulation layer is laid between the measuring instrument and the measured device.
